(19) United States
(12) Patent Application Publication
(10) Pub. No.: US 2021/0276204 A1
(43) Pub. Date: Sep. 9, 2021

(54) OUT-THE-FRONT SWITCHBLADE

(71) Applicant: Anthony Louis Marfione, Fletcher, NC (US)

(72) Inventor: Anthony Louis Marfione, Fletcher, NC (US)

(21) Appl. No.: 16/808,929

(22) Filed: Mar. 4, 2020

(51) Int. Cl. B26B 1/08; B26B 1/10

(52) U.S. Cl. CPC B26B 1/08; B26B 1/10

(57) ABSTRACT

An out-the-front switchblade includes a first longitudinal rail and a second longitudinal rail radially separated from and substantially parallel to the first longitudinal rail. Each of the first and second longitudinal rails has a front end opposed to a rear end. A blade having a cutting edge has a retracted position in which the cutting edge is between the first and second longitudinal rails and a deployed position in which the cutting edge is not between the first and second longitudinal rails. A scale is molded around at least a portion of the first and second longitudinal rails.

### FIELD OF THE INVENTION

The present invention generally involves an out-the-front switchblade. In particular embodiments, the out-the-front switchblade may be single or double action.

### BACKGROUND OF THE INVENTION

Pocket knives provide a convenient tool for cutting that may be easily carried by a user for deployment when desired. For some pocket knife designs, two hands are needed to deploy and retract a blade, while other designs include a spring that assists a user to deploy and/or retract the blade using a single hand. Each design balances the convenience and speed of operation with increased risk associated with inadvertent operation.

An out-the-front switchblade is a particular style of pocket knife in which a blade automatically deploys from a front end of a casing when an actuator is operated. In a single action out-the-front switchblade, the blade must be manually retracted into the casing. In a double action out-the-front switchblade, movement of the actuator deploys and retracts the blade.

The casing for an out-the-front switchblade typically includes precisely located slots, recesses, and/or pockets to hold and support internal components that provide the desired functionality. The casing is often constructed from metal or metal-alloys having sufficient hardness and strength to ensure reliable operation over years of repetitive use, and fabrication of the casing requires time-consuming and expensive machining to achieve the desired tolerances. The materials and precise manufacturing tolerances associated with the casing increases the cost of out-the-front switchblades compared to other switchblade designs. Therefore, the need exists for an improved out-the-front switchblade that does not require a precisely machined casing to provide the desired reliability and functionality.

### BRIEF DESCRIPTION OF THE INVENTION

Aspects and advantages of the invention are set forth below in the following description, or may be obvious from the description, or may be learned through practice of the invention.

One embodiment of the present invention is an out-the-front switchblade that includes a first longitudinal rail and a second longitudinal rail radially separated from and substantially parallel to the first longitudinal rail. Each of the first and second longitudinal rails has a front end opposed to a rear end. A blade having a cutting edge has a retracted position in which the cutting edge is between the first and second longitudinal rails and a deployed position in which the cutting edge is not between the first and second longitudinal rails. A scale is molded around at least a portion of the first and second longitudinal rails.

An alternate embodiment of the present invention is an out-the-front switchblade that includes a first scale and a second scale opposed to the first scale, wherein the first and second scales define a cavity. A blade has a cutting edge, and the blade has a retracted position in which the cutting edge is inside the cavity and a deployed position in which the cutting edge is outside of the cavity. A first rail extends longitudinally in the cavity, and a second rail extends longitudinally in the cavity radially separated from and substantially parallel to the first rail. Each of the first and second rails has a front end opposed to a rear end, and the first scale is molded around at least a portion of the first and second rails.

In yet another embodiment of the present invention, an out-the-front switchblade includes a first metallic rail and a second metallic rail radially separated from and substantially parallel to the first metallic rail. Each of the first and second metallic rails has a front end opposed to a rear end. A blade has a cutting edge, and the blade has a retracted position in which the cutting edge is between the first and second metallic rails and a deployed position in which the cutting edge is not between the first and second metallic rails. A non-metallic scale is molded around at least a portion of the first and second metallic rails.

Those of ordinary skill in the art will better appreciate the features and aspects of such embodiments, and others, upon review of the specification.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a top plan view of a switchblade according to one embodiment of the present invention with the blade in a deployed position;

FIG. 2 is an exploded view of the switchblade shown in FIG. 1;

FIG. 3 is a cross-section view of the switchblade in a retracted position taken along line 3-3 of FIG. 1;

FIG. 4 is an enlarged perspective view of a rail shown in FIG. 2;

FIG. 5 is an enlarged perspective view of front and rear blade stops shown in FIG. 2;

FIG. 6 is a perspective view of the rails and front and rear blade stops shown in FIG. 2 assembled as a chassis;

FIG. 7 is a perspective view of the bottom scale shown in FIG. 2 molded around the chassis shown in FIG. 6;

FIG. 8 is a top plan view of the switchblade shown in FIG. 1 in the retracted position with the top scale removed, the actuator in the retracted position, and the rear lock engaged with the blade;

FIG. 9 is a top plan view of the switchblade shown in FIG. 1 in the retracted position with the top scale removed, the actuator in the deployed position, and the rear lock released from the blade;

FIG. 10 is a top plan view of the switchblade shown in FIG. 1 in the deployed position with the top scale removed, the actuator in the deployed position, and the front lock engaged with the blade; and

FIG. 11 is a top plan view of the switchblade shown in FIG. 1 in the deployed position with the top scale removed, the actuator in the retracted position, and the front lock released from the blade.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. As used herein, the term “front” shall refer to the end of an out-the-front switchblade from which a blade deploys, and the term “rear” shall refer to the opposite end of the switchblade. As used herein, the term “longitudinal” shall refer to the direction between the front and rear of the switchblade, and the term “radial” shall refer to any direction perpendicular to the longitudinal direction.

Embodiments of the present invention include an out-the-front switchblade that may be constructed from less expensive materials to reduce the manufacturing costs while still providing the desired functionality and durability. In particular embodiments, a pair of longitudinal, radially separated rails may form a chassis. The longitudinal rails may be metal-injection-molded, sintered, and machined to achieve the desired manufacturing tolerances. A casing molded around at least a portion of the chassis provides the desired convenience, functionality, and reliability associated with more expensive out-the-front switchblade designs.

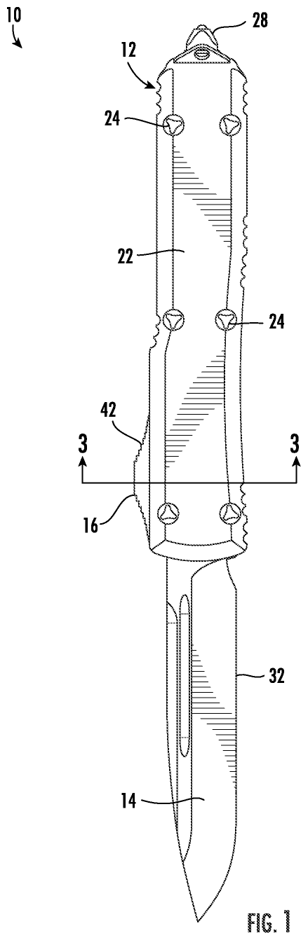

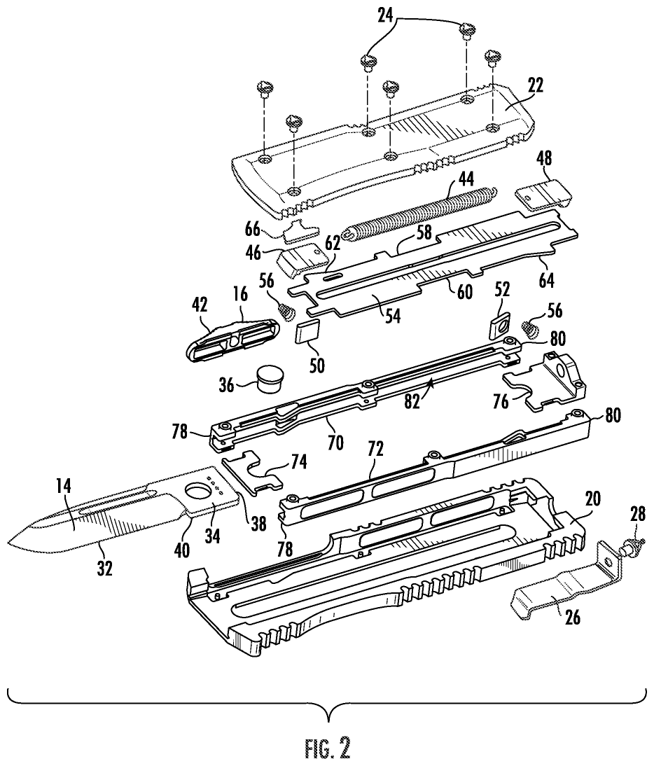

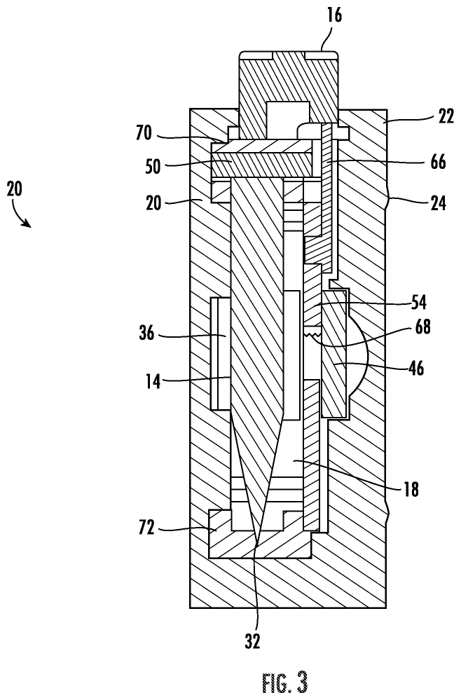

FIG. 1 provides a top plan view of an out-the-front switchblade 10 according to one embodiment of the present invention in a deployed position. FIG. 2 provides an exploded view of the switchblade 10 shown in FIG. 1, and FIG. 3 provides a cross-section view of the switchblade 10 taken along line 3-3 of FIG. 1 in a retracted position. As shown in FIG. 1, the switchblade 10 generally includes a casing 12, a blade 14, and an actuator 16. The casing 12 defines a cavity 18 (shown in FIG. 3) that contains the various components for operating the switchblade 10. The casing 12 may include a first or bottom scale 20 connected to a second or top scale 22 by screws 24 or other attachment means. In the particular embodiment shown in FIGS. 1-3, the screws 24 may be inserted through the top scale 22 to provide threaded engagement without passing through the bottom scale 20, resulting in a visually clean appearance of the bottom scale 20 of the casing 12. The switchblade 10 may include an optional pocket clip 26 and glass break 28 at the rear of the casing 12 so that the pocket clip 26 extends over the bottom scale 20, while the top scale 22 remains relatively unadorned.

The blade 14 generally has one or more cutting edges 32 and a tang 34, and the blade 14 can move between the deployed position and the retracted position. In the deployed position, as shown in FIGS. 1, 2, 10, and 11, the cutting edge 32 is outside of the cavity 18 of the casing 12 to allow use of the cutting edge 32 as desired. In the retracted position, as shown in FIGS. 3, 8, and 9, the cutting edge 32 is inside the cavity 18 of the casing 12 to shield the cutting edge 32 from inadvertent contact that might damage the blade 14 or cause harm to personnel or objects.

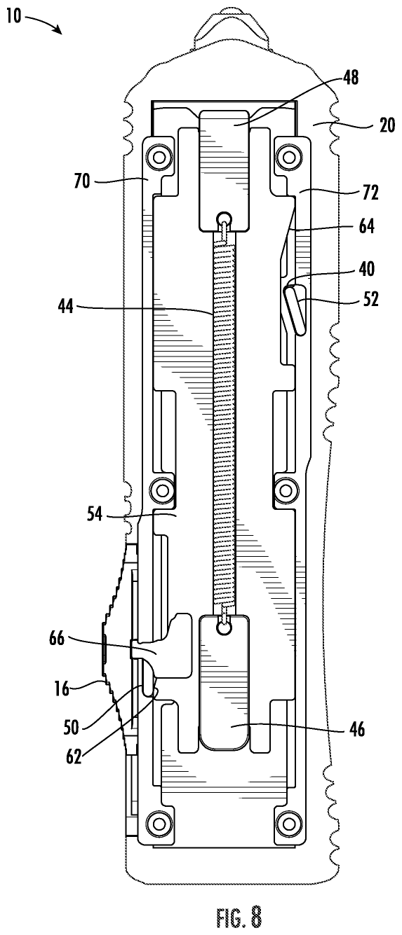

As shown in FIG. 2, the tang 34 of the blade 14 may include a post 36 longitudinally separated from a rear surface 38 and a notch 40 in one or both sides. In particular embodiments, the post 36 may be simply a projection from the tang 34, while in other embodiments, as shown in FIG. 2, the post 36 may be a separate part threaded or press-fit into the tang 34. The purpose and operation of the post 36, rear surface 38, and notch 40 will be described in more detail with respect to operation of the blade 14 between the retracted and deployed positions as shown in FIGS. 8-11.

The actuator 16 is slidably engaged with the casing 12 to reposition the blade 14 between the retracted and deployed positions. As such, the actuator 16 may include opposing sloped surfaces 42 that facilitate sliding the actuator 16 forward to deploy the blade 14 and rearward to retract the blade 14.

As shown most clearly in FIGS. 2 and 3, a spring 44, front and rear operators 46, 48, front and rear locks 50, 52, and a slider 54 are located inside the cavity 18 of the casing 12. The spring 44 connects the front operator 46 to the rear operator 48. As will be explained in more detail with respect to FIGS. 8-11, the front and rear operators 46, 48 alternately engage with the blade 14 and slider 54 to move the blade 14 between the retracted and deployed positions. The front and rear locks 50, 52 are pivotally connected and biased inward in the cavity 18 by springs 56. With the blade 14 in the retracted position, the rear lock 52 is in biased engagement with the notch 40 in the tang 34 to retain the blade 14 inside the casing 12. With the blade 14 in the deployed position, the front lock 50 is in biased engagement with the rear surface 38 of the tang 34 to hold the blade 14 outside of the casing 12.

The slider 54 has a first side 58 opposed to a second side 60, a front sloped surface 62, and a rear sloped surface 64. In the particular embodiment shown in FIGS. 1-11, the front sloped surface 62 is located or defined on the first side 58 of the slider 54, and the rear sloped surface 64 is located or defined on the second side 60 of the slider 54. In alternate embodiments, the front and rear sloped surfaces 62, 64 may be located or defined on the same side of the slider 54, and the present invention is not limited to the specific location of the front and rear sloped surfaces 62, 64 unless specifically recited in the claims.

A tab 66 is releasably connected to the slider 54 and engaged with the actuator 16. The releasable connection between the tab 66 and the slider 54 may be by slip fit, press fit, adhesive, or other similar methods known to one of ordinary skill in the art for releasably connecting components. The tab 66 may extend from whichever side of the slider 54 is closest to the actuator 16 so that the tab 66 engages with the actuator 16. For example, in the particular embodiment shown in FIGS. 2-11, the tab 66 extends from the first side 58 of the slider 54. In this manner, forward or rearward movement of the actuator 16 moves the slider 54 the same direction and distance. Specifically, forward movement of the actuator 16 and slider 54 causes the rear sloped surface 64 to engage with the rear lock 52 to pivot the rear lock 52 outward, disengaging the rear lock 52 from the notch 40 in the tang 34 to allow the blade 14 to move to the deployed position. Conversely, rearward movement of the actuator 16 and slider 54 causes the front sloped surface 62 to engage with the front lock 50 to pivot the front lock 50 outward, disengaging the front lock 50 from the rear surface 38 of the tang 34 to allow the blade 14 to move to the retracted position.

FIGS. 2 and 3 illustrate the reduced manufacturing and maintenance costs provided by the tab 66. As shown in FIGS. 2 and 3, for example, releasably connecting the tab 66 to the slider 54 allows the slider 54 to have a uniform thickness 68 between the first side 58 and the second side 60 which simplifies manufacturing costs associated with the slider 54. In addition, as shown most clearly in FIG. 3, the radial offset between the tab 66 and the slider 54 allows the tab 66 to connect the slider 54 to the actuator 16 while also allowing the slider 54 to move longitudinally inside the cavity 18 without interfering with the other components, such as the front lock 50, inside the cavity 18.

FIGS. 2 and 3 illustrate additional novel features that reduce the material costs and manufacturing costs associated with various embodiments of the switchblade 10. For example, the switchblade 10 may include a first rail 70, a second rail 72, a front blade stop 74, and a rear blade stop 76. The first and second rails 70, 72 extend longitudinally in the cavity 18, with the second rail 72 radially separated from and substantially parallel to the first rail 70.

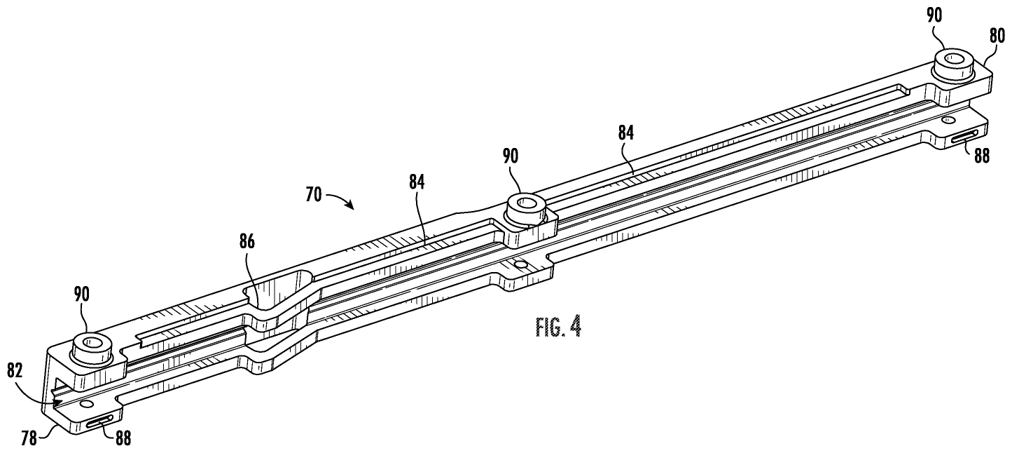

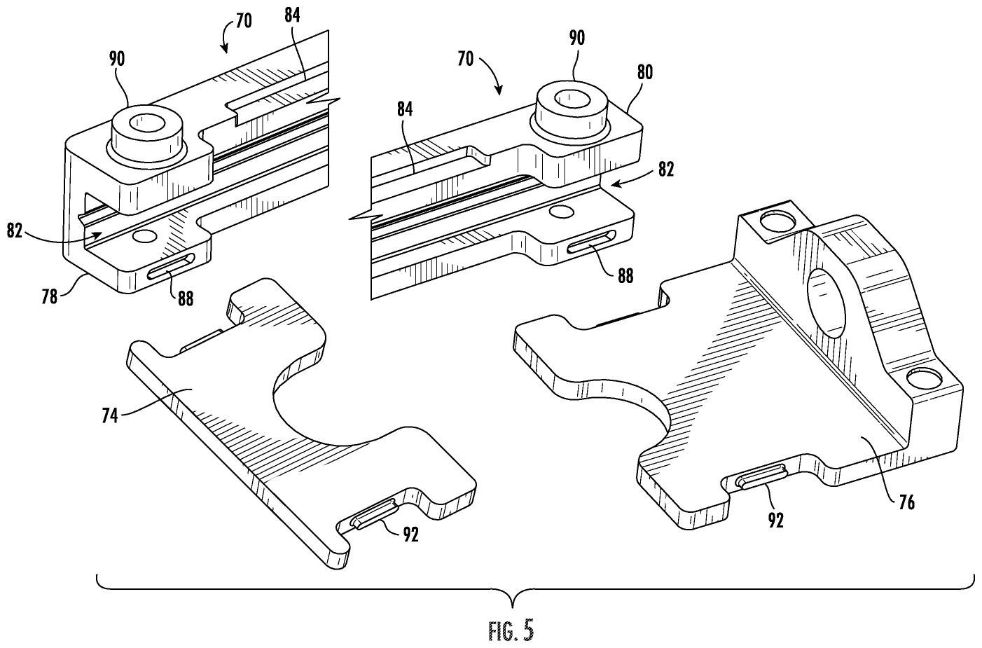

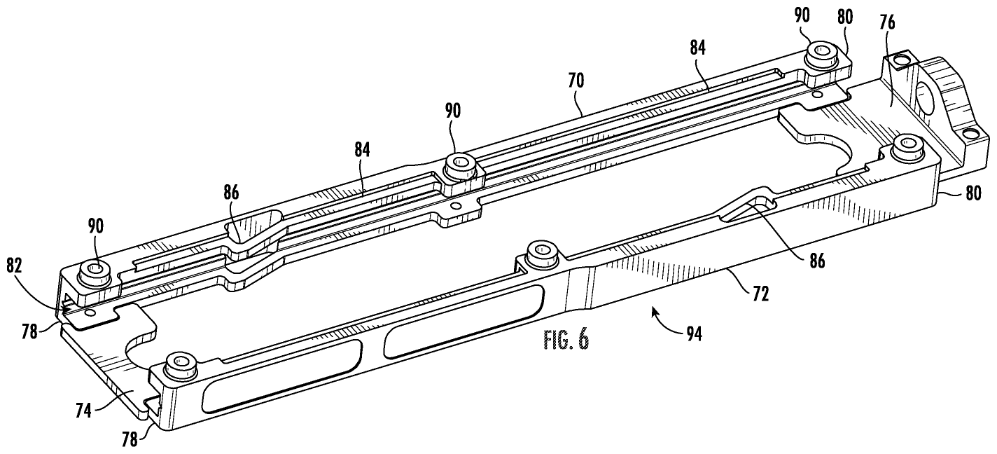

FIG. 4 provides an enlarged perspective view of the first rail 70, with the second rail 72 being an inverted mirror image of the first rail 70, according to the embodiment shown in FIG. 2. As shown in FIGS. 2 and 4, each rail 70, 72 has a front end 78 opposed to a rear end 80 and defines a longitudinal channel 82 in which the blade 14 slides when moving between the retracted and deployed positions. In addition, each rail 70, 72 may further define multiple optional structural features precisely located to retain other components inside the cavity 18 during operation of the switchblade 10. For example, each rail 70, 72 may define one or more longitudinal flanges 84, pockets 86, slots 88, and/or bosses 90. The longitudinal flanges 84 may extend along portions of the rails 70, 72 to provide a smooth surface on which the slider 54 may ride inside the cavity 18. The pockets 86 may hold the respective front and rear locks 50, 52 and associated springs 56. The slots 88 may receive complementary tabs 92 on the front and rear blade stops 74, 76, as will be described with respect to FIGS. 5 and 6. The bosses 90 may facilitate the manufacture of the rails 70, 72 before being threaded for receipt of the screws 24 to secure the casing 12.

FIG. 5 provides an enlarged perspective view of the front and rear blade stops 74, 76 shown in FIG. 2. As shown in FIGS. 2 and 5, the tabs 92 on either side of the front and rear blade stops 74, 76 may fit in the corresponding slots 88 in the rails 70, 72 to rigidly engage the front and rear blade stops 74, 76 to the rails 70, 72.

The first and second rails 70, 72 and front and rear blade stops 74, 76 may be machined or molded from aluminum, steel, or other metallic elements, alloys, or compounds having the desired strength, hardness, and wear characteristics. For example, the rails 70, 72 and front and rear blade stops 74, 76 may be molded from powdered aluminum, steel, or other metallic elements, alloys, or compounds using a process known as Metal Injection Molding (MIM). Once molded, the rails 70, 72 and front and rear blade stops 74, 76 may be sintered, deburred, and machined to achieve the desired precise dimensions.

FIG. 6 provides a perspective view of the rails 70, 72 and front and rear blade stops 74, 76 assembled as a chassis 94. As shown in FIG. 6, once assembled to form the chassis 94, the front blade stop 74 extends radially from the front end 78 of the first longitudinal rail 70 to the front end 78 of the second longitudinal rail 72, and the rear blade stop 76 extends radially from the rear end 80 of the first longitudinal rail 70 to the rear end 80 of the second longitudinal rail 72. In this manner, the assembled chassis 94 provides the desired strength and hardness to support the various components to ensure reliable operation of the switchblade 10. The assembled chassis 94 may then be placed in a mold to allow the bottom scale 20 to be molded around the chassis 94.

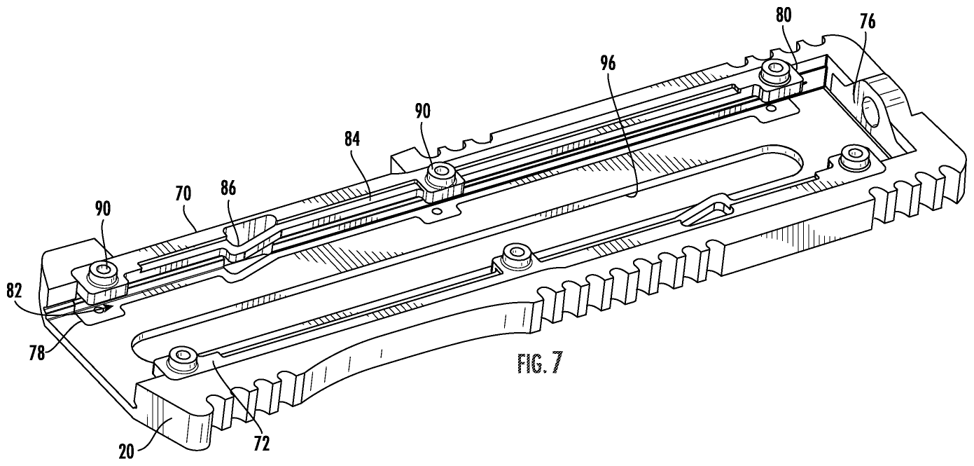

FIG. 7 provides a perspective view of the bottom scale 20 shown in FIG. 2 molded around the chassis 94 shown in FIG. 6. As shown in FIG. 7, the bottom scale 20 may be molded around at least a portion of said first and second rails 70, 72. In addition, the molded bottom scale 20 may fully cover the front blade stop 74 and partially cover the rear blade stop 76, creating a longitudinal oval 96 in which the post 36 may travel. The bottom scale 20 may be molded from non-metallic materials such as plastic, fiberglass, polymers, or a combination of composite materials that are readily molded and do not require the strength or hardness already provided by the chassis 94, reducing the material costs and manufacturing costs previously required for the bottom scale 20. The top scale 22, shown in FIG. 2, may be similarly separately molded for subsequent assembly to the rails 70, 72 using the screws 24 and bosses 90, as previously described.

Operation of the switchblade 10 between the retracted and deployed positions will now be described with respect to FIGS. 8-11. As shown in FIG. 8, the actuator 16 is in the rearward or retracted position with the blade 14 retracted inside the cavity 18 and the cutting edge 32 between the first and second rails 70, 72. The rear lock 52 is engaged with the notch 40 in the tang 34 to retain the blade 14 in the retracted position, and the rear surface 38 of the blade 14 or tang 34 is engaged with the rear operator 48 and rear blade stop 76.

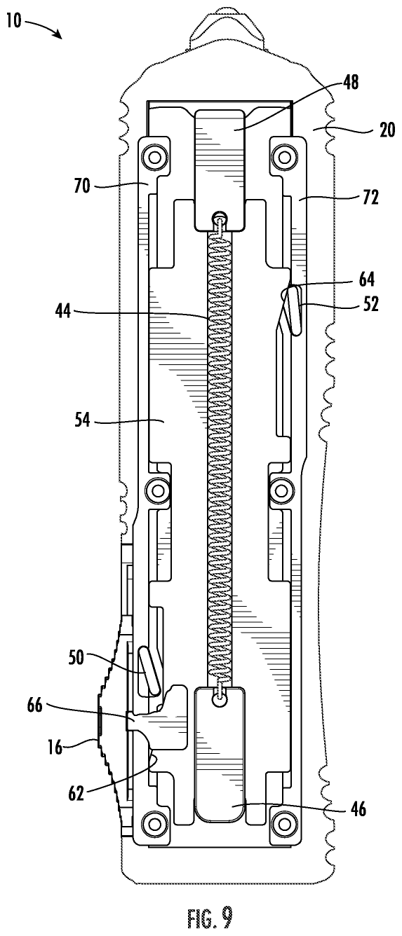

To deploy the blade 14, the actuator 16 is moved to the forward or deployed position as shown in FIG. 9, and the engagement between the tab 66 and the actuator 16 causes the slider 54 to move forward with the actuator 16. As the slider 54 initially moves forward in the longitudinal flanges 84 of the rails 70, 72, the rear lock 52 remains engaged with the notch 40 in the tang 34 to prevent the blade 14 from moving. The front of the slider 54 engages with the front operator 46 to move the front operator 46 forward and create tension in the spring 44 between the front and rear operators 46, 48. Eventually, the rear sloped surface 64 on the second side 60 of the slider 54 disengages the rear lock 52 from the notch 40 to release the blade 14, as shown in FIG. 9.

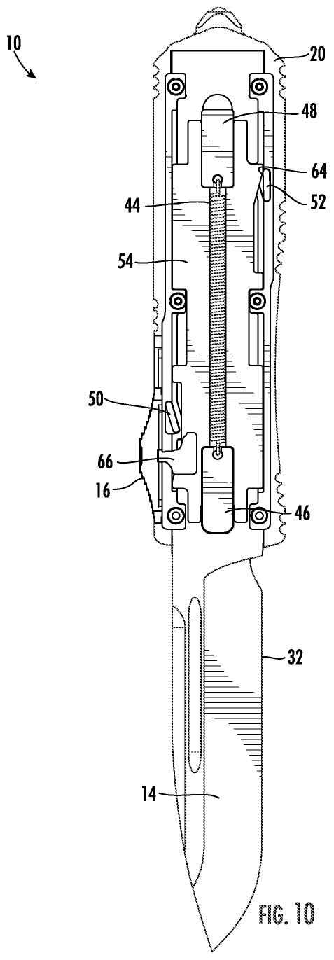

When the rear lock 52 disengages from the notch 40, the tension in the spring 44 causes the rear operator 48 to eject the blade 14 out of the cavity 18 to the deployed position, as shown in FIG. 10. The blade 14 moves out of the cavity 18 until the post 36 contacts front blade stop 74 to prevent further travel of the blade 14 out of the cavity 18. As shown in FIG. 10, the actuator 16 is in the forward or deployed position with the blade 14 deployed outside of the cavity 18. In the deployed position, the front lock 50 is engaged with the rear surface 38 of the tang 34 to hold the blade 14 in the deployed position.

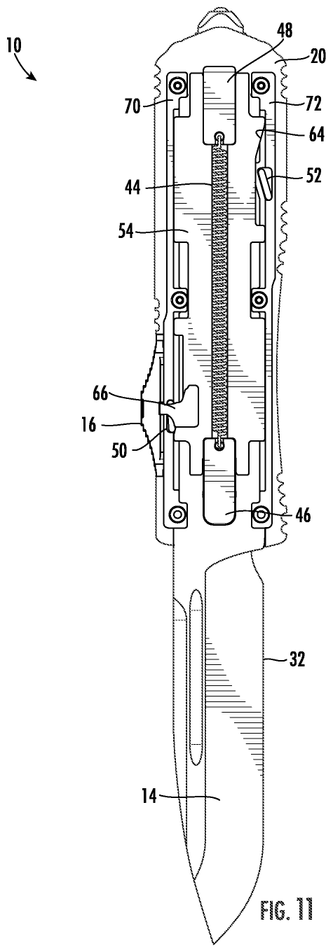

To retract the blade 14, the actuator 16 is moved to the rearward or retracted position as shown in FIG. 11, and the engagement between the tab 66 and the actuator 16 causes the slider 54 to move rearward with the actuator 16. As the slider 54 initially moves rearward in the longitudinal flanges 84 of the rails 70, 72, the front lock 50 remains engaged with the rear surface 38 of the tang 34 to prevent the blade 14 from moving. The rear of the slider 54 engages with the rear operator 48 to move the rear operator 48 rearward and create tension in the spring 44 between the front and rear operators 46, 48. Eventually, the front sloped surface 62 on the first side 58 of the slider 54 disengages the front lock 50 from the rear surface 38 of the tang 34 to release the blade 14, as shown in FIG. 11.

When the front lock 50 disengages from the rear surface 38 of the tang 34, the tension in the spring 44 causes the front operator 46 to retract the blade 14 into the cavity 18 to the retracted position, as shown in FIG. 8. The blade 14 moves into the cavity 18 until the rear surface 38 of the tang 34 contacts the rear operator 48 and rear blade stop 76, and the rear lock 52 again engages with the notch 40 in the tang 34 to retain the blade 14 in the retracted position.

The embodiments described and illustrated with respect to FIGS. 1-11 provide several advantages over conventional double action switchblades. For example, the more costly materials and manufacturing time is limited to the structural components that form the chassis 94, namely the longitudinal rails 70, 72 and the front and rear blade stops 74, 76. In contrast, the bottom scale 20 may be molded around portions of the chassis 94 using less expensive plastic, fiberglass, polymers, or a combination of composite materials that are readily molded and do not require the strength or hardness already provided by the chassis 94. Therefore, embodiments of the present invention may provide an out-the-front switchblade 10 having the functionality and durability of more expensive switchblades.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

1. An out-the-front switchblade, comprising:
a first longitudinal rail;
a second longitudinal rail radially separated from and substantially parallel to said first longitudinal rail, wherein each of said first and second longitudinal rails has a front end opposed to a rear end;
a blade having a cutting edge, wherein said blade has a retracted position in which said cutting edge is between said first and second longitudinal rails and a deployed position in which said cutting edge is not between said first and second longitudinal rails; and
a scale molded around at least a portion of said first and second longitudinal rails.

2. The out-the-front switchblade as in claim 1, wherein at least one of said first or second longitudinal rails defines a longitudinal channel in which said blade slides when moving between said retracted position and said deployed position.

3. The out-the-front switchblade as in claim 1, wherein at least one of said first or second longitudinal rails includes a front lock that engages with said blade in said deployed position.

4. The out-the-front switchblade as in claim 1, wherein at least one of said first or second longitudinal rails includes a rear lock that engages with said blade in said retracted position.

5. The out-the-front switchblade as in claim 1, further comprising a front blade stop that extends radially from said front end of said first longitudinal rail to said front end of said second longitudinal rail, wherein said front blade stop retains said blade when said blade is in said deployed position.

6. The out-the-front switchblade as in claim 1, further comprising a rear blade stop that extends radially from said rear end of said first longitudinal rail to said rear end of said second longitudinal rail, wherein said blade contacts said rear blade stop when said blade is in said retracted position.

7. An out-the-front switchblade, comprising:
a first scale and a second scale opposed to said first scale, wherein said first and second scales define a cavity;
a blade having a cutting edge, wherein said blade has a retracted position in which said cutting edge is inside said cavity and a deployed position in which said cutting edge is outside of said cavity;
a first rail that extends longitudinally in said cavity;
a second rail that extends longitudinally in said cavity radially separated from and substantially parallel to said first rail, wherein each of said first and second rails has a front end opposed to a rear end; and
wherein said first scale is molded around at least a portion of said first and second rails.

8. The out-the-front switchblade as in claim 7, wherein at least one of said first or second rails defines a longitudinal channel in which said blade slides when moving between said retracted position and said deployed position.

9. The out-the-front switchblade as in claim 7, wherein at least one of said first or second rails includes a front lock that engages with said blade in said deployed position.

10. The out-the-front switchblade as in claim 7, wherein at least one of said first or second rails includes a rear lock that engages with said blade in said retracted position.

11. The out-the-front switchblade as in claim 7, further comprising a front blade stop that extends radially from said front end of said first rail to said front end of said second rail, wherein said front blade stop retains said blade when said blade is in said deployed position.

12. The out-the-front switchblade as in claim 7, further comprising a rear blade stop that extends radially from said rear end of said first rail to said rear end of said second rail, wherein said blade contacts said rear blade stop when said blade is in said retracted position.

13. An out-the-front switchblade, comprising:
a first metallic rail;
a second metallic rail radially separated from and substantially parallel to said first metallic rail, wherein each of said first and second metallic rails has a front end opposed to a rear end;
a blade having a cutting edge, wherein said blade has a retracted position in which said cutting edge is between said first and second metallic rails and a deployed position in which said cutting edge is not between said first and second metallic rails; and
a non-metallic scale molded around at least a portion of said first and second metallic rails.

14. The out-the-front switchblade as in claim 13, wherein at least one of said first or second metallic rails defines a longitudinal channel in which said blade slides when moving between said retracted position and said deployed position.

15. The out-the-front switchblade as in claim 13, wherein at least one of said first or second metallic rails includes a front lock that engages with said blade in said deployed position.

16. The out-the-front switchblade as in claim 13, wherein at least one of said first or second metallic rails includes a rear lock that engages with said blade in said retracted position.

17. The out-the-front switchblade as in claim 13, further comprising a front blade stop that extends radially from said front end of said first metallic rail to said front end of said second metallic rail, wherein said front blade stop retains said blade when said blade is in said deployed position.

18. The out-the-front switchblade as in claim 13, further comprising a rear blade stop that extends radially from said rear end of said first metallic rail to said rear end of said second metallic rail, wherein said blade contacts said rear blade stop when said blade is in said retracted position.
